(19) United States
(12) Patent Application Publication
(10) Pub. No.: US 2007/0076747 A1
(43) Pub. Date: Apr. 5, 2007

(54) Periodic network controller power-down

(76) Inventor: Amir Zinaty, Haifa (IL)

Correspondence Address: SCHWEGMAN, LUNDBERG, WOESSNER & KLUTH, P.A., P.O. BOX 2938, MINNEAPOLIS, MN, 55402, US

(21) Appl. No.: 11/241,755

(22) Filed: Sep. 30, 2005

(51) Int. Cl. H04L 12/66

(52) U.S. Cl. 370/463; 370/420

(57) ABSTRACT

Some embodiments of the invention include apparatus, systems, and methods to periodically power-down at least a portion of a network controller to improve power management. Other embodiments are described and claimed.

### FIELD

Embodiments of the present invention relate generally to power management in electronic devices, and particularly to managing power in network controllers.

### BACKGROUND

Many communication systems have a structure based on the Open System Interconnect (OSI) model. The OSI model defines seven layers for a communication system. Two of the layers are a physical (PHY) layer and a Data Link layer. The Data Link layer includes a sub-layer called a Media Access Control (MAC) layer. The PHY layer has components such as transmitters and receivers for transferring data. The MAC layer controls the transfer of data between the PHY layer and other parts of the system.

Some systems use the MAC and PHY layers to transfer data with other systems or with a network via a communication link connected to the PHY. In some of these systems, a power supply is connected to the MAC and PHY layers at all times even when no communication link exists between the MAC and PHY layers and other systems or networks. Connecting the MAC and PHY layers to the power supply at all times when a communication link does not exist may waste power.

### BRIEF DESCRIPTION OF THE DRAWINGS

FIG. 1 shows an apparatus according to an embodiment of the invention.

FIG. 2 shows an example of a timing diagram of a periodic power-down process for FIG. 1.

FIG. 3 shows a system according to an embodiment of the invention.

FIG. 4 is a flowchart showing a method according to an embodiment of the invention.

FIG. 5 is a block diagram of an article according to an embodiment of the invention.

### DESCRIPTION OF THE EMBODIMENTS

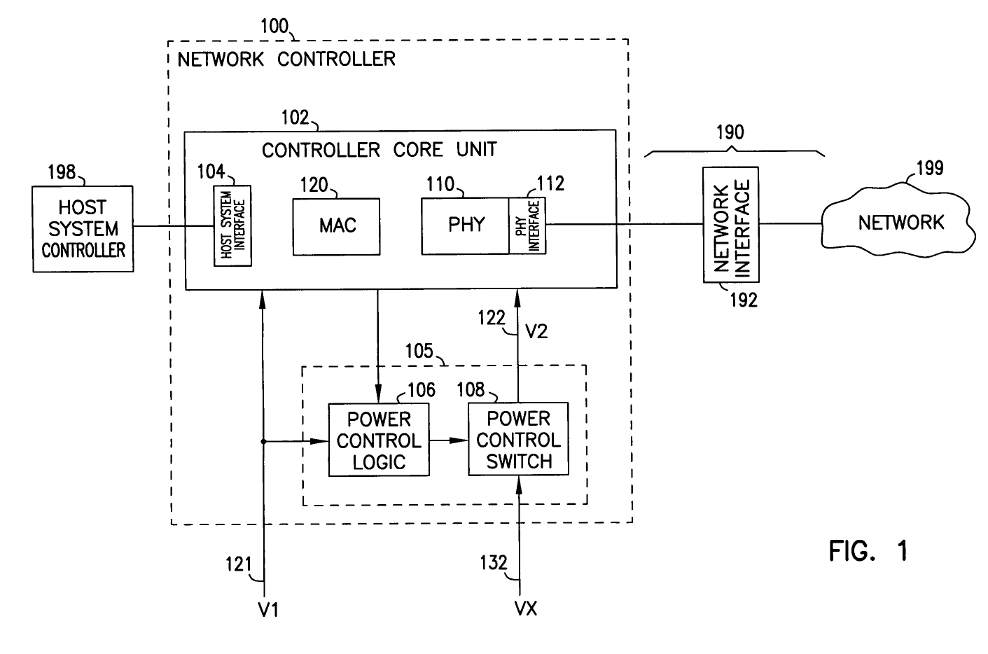

FIG. 1 shows an apparatus according to an embodiment of the invention. Apparatus or network controller 100 includes a controller core unit 102 having a physical layer circuitry PHY 110 and a MAC circuit 120, a host system interface 104, and a power control circuit 105 including a power control logic 106 and a power control switch 108. Controller core unit 102 may include other circuits to perform other functions. In some embodiments, network controller 100 is a local area network (LAN) controller.

PHY 110 includes a PHY interface 112 to transfer data between network controller 100 and a network 199 via a network link 190. In some embodiments, PHY interface 112 includes transmitters and receivers to transfer data to and from PHY 110. MAC circuit 120 provides control functions to control data transferred in PHY 110. In some embodiments, PHY 110 and MAC circuit 120 correspond to the PHY and MAC layers in the OSI model. Network link 190 includes a network interface 192 to allow transfer of data between network controller 100 and network 199. Network interface 192 may include magnetic components, passive coupling components, or other types of connections. Host system interface 104 allows communication between network controller 100 and a host system controller 198. Host system controller 198 may include any combination of a central processing unit (CPU) and a chipset.

Network controller 100 is configured to save power by reducing or eliminating leakage power (leakage current) when network link 190 is not connected (unconnected) to PHY 110 or when network link 190 is connected to PHY 110 but no active communication is exchanged between network controller 100 and network 199.

In FIG. 1, some components of network controller 100 are shown separately as an example embodiment. In some embodiments, one or more components of network controller 100 may be incorporated into one component. For example, power control logic 106, power control switch 108, or both, may be incorporated into controller core unit 102. In some embodiments, one or more of the components of network controller 100 may be located in one or multiple devices. For example, PHY 1 10 may be located in a device separated from the rest of network controller 100.

Controller core unit 102 receives a first voltage V1 from a first power terminal 121, and a second voltage V2 from a second power terminal 122. In some embodiments, V1 is un-switched voltage provided by one or more power sources. In some embodiments, V1 is provided to at least a portion of network controller 100, such as to controller core unit 102, at all times. V2 is switched voltage provided by one or more power sources, such as VX, via power control switch 108. In some embodiments, V1 and V2 have different voltage values. For example, V1 may be 3.3 volts or 1.05 volts, or both 3.3 volts and 1.05 volts; V2 may be 1.08 volts or 1.05 volts, or both 1.08 volts and 1.05 volts. V1 and V2 may have other voltage values. V2 is provided based on VX at power terminal 132.

Power control switch 108 is configured to connect power terminal 122 to power terminal 132 such that V2 is the same as VX when power terminal 122 is connected to power terminal 132. In some embodiments, VX may be generated from a voltage regulator inside network controller 100. In some embodiments, V1 and VX are supplied by power sources external to network controller 100 or by a battery. Power control logic 106 is responsive to controller core unit 102 to control V2 via power control switch 108.

In some embodiments, some circuitry of network controller 100, such as circuitry in controller core unit 102 or in PHY 110, may operate with a voltage such as V2 while some other circuitry of network controller 100 may operate with a voltage such as V1. As mentioned above, in some embodiments, V1 and V2 have different values. Thus, in some embodiments, incorporating both V1 and V2 in network controller 100 may allow network controller 100 to use different voltage in different circuitry.

Power control circuit 105 is configured to connect and disconnect at least a portion of controller core unit 102 from V2 at different times. For example, power control circuit 105 may disconnect PHY 110 from V2 during a power-down interval of network controller 100. In the power-down interval, all or most circuitry of network controller 100 is inactive. Network controller 100 consumes less power in the power-down interval than in other modes or intervals such as a power-up mode or active interval. In FIG. 1, power from a power terminal may leak during the power-down interval. For example, power from power terminal 122 may leak during the power-down interval. Disconnecting at least a portion of controller core unit 102 from V2 during the power-down interval may reduce the leakage power, thereby saving power.

Power control circuit 105 enables at least a portion of controller core unit 102 to be placed into the power-down interval based on conditions of network controller 100. For example, controller core unit 102 may be placed into the power-down interval when network link 190 is not connected to PHY interface 112. In another example, controller core unit 102 may be placed into the power-down interval when network link 190 is connected to PHY 110 but no active communication is exchanged between the network controller 100 and network 199.

PHY 110 is configured to detect a presence and absence of network link 190 at PHY interface 112. In some embodiments, at least a portion of controller core unit 102 may be placed into the power-down interval when network link 190 is absent from PHY interface 112. For example, PHY 110 may be placed into the power-down interval when network link 190 is absent from PHY interface 112. In some embodiments, during the power-down interval, power control circuit 105 may disconnect at least a portion of controller core unit 102 from V2 when network link 190 is absent from PHY interface 112. For example, power control circuit 105 may disconnect PHY 110 from V2 when network link 190 is absent from PHY interface 112.

In some embodiments, the presence and absence of network link 190 at PHY interface 112 is represented by the presence and absence of a link energy at PHY interface 112. In some embodiments, the link energy is represented by a link signal or a link pulse. In these embodiments, PHY 110 periodically detects the presence or absence of network link 190 by detecting the presence or absence of the link energy from PHY interface 112. In some embodiments, PHY 110 periodically detects a presence or absence of the link energy by detecting the presence or absence of the link signal. The absence of the link signal may correspond to the absence of the link energy. The presence of the link signal may correspond to the presence of the link energy. PHY interface 112 may include terminals to connect to network link 190. In some embodiments, PHY 110 may sense the voltage levels of the terminals of PHY interface 112 to determine the presence or absence of the link energy.

In some embodiments, the link signal is sent to PHY interface 112 from network 199. In other embodiments, the link signal is sent to PHY interface 112 by network controller 100. Thus, in some embodiments, the link energy is absent when PHY interface 112 does not receive the link signal; the link energy is present when PHY interface 112 receives the link signal. The link signal may conform to one or more standard protocols. For example, the link signal may be a full pulse link (FPL) or a normal pulse link (NPL) according to the Ethernet transfer protocols. In some embodiments, detection of the link energy is performed by a circuit outside PHY 110.

In some embodiments, the presence or absence of network link 190 at PHY interface 112 is represented by a value of an impedance at PHY interface 112. In some embodiments, PHY 110 is configured to determine the value of the impedance at PHY interface 112. In some embodiments, the values of the impedance at PHY interface 112 correspond to the presence and absence of network link 190 at PHY interface 112. For example, network link 190 is absent from PHY interface 112 when the impedance at PHY interface 112 has a first value; network link 190 is present at PHY interface 112 when the impedance at PHY interface 112 has a second value. In some embodiments, detecting the presence and absence of network link 190 is performed by other techniques.

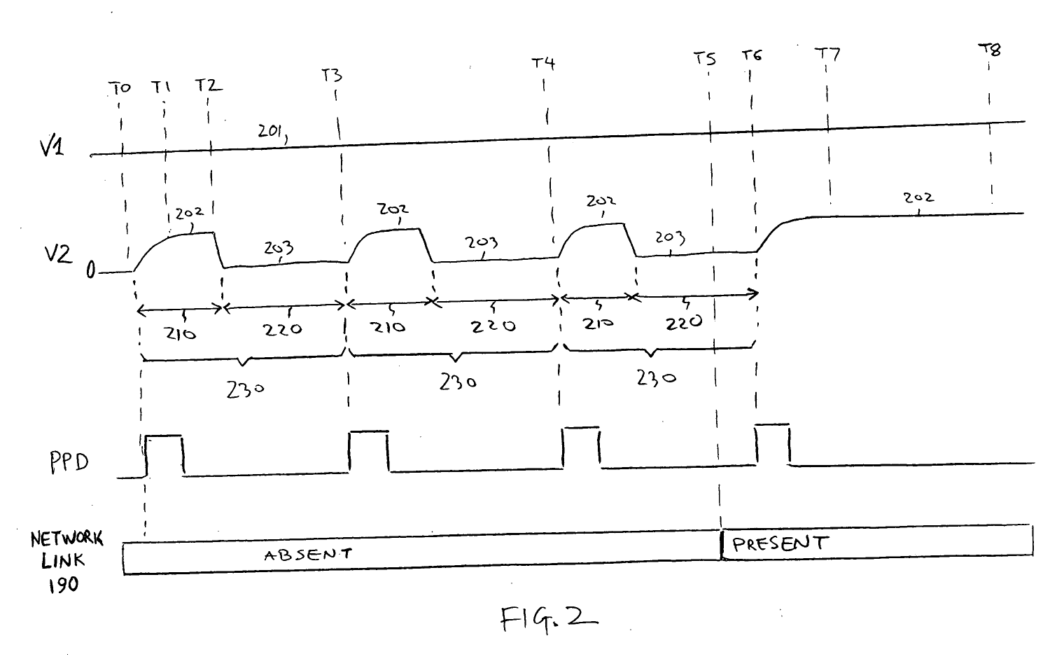

FIG. 2 is an example of a timing diagram of a periodic power-down process for FIG. 1. FIG. 2 shows voltage levels of V1 and V2 between times T0 through T8. V1 remains unchanged at a voltage level 201. V2 periodically switches between voltage level 202 and voltage level 203 between times T0 through T7. Voltage levels 201 and 202 correspond to positive voltage levels. For example, voltage level 201 may correspond to 3.3 volts or 1.05 volts; voltage level 202 may correspond to 1.08 volts or 1.05 volts. Voltage level 203 corresponds to ground or zero.

FIG. 2 also shows time intervals 210 and time intervals 220. Each time interval 210 corresponds to a power-up or active time interval. Each time interval 220 corresponds to a power-down time interval. Since the voltage level of V2 is zero during each time interval 220, leakage power from power terminal 122 of FIG. 1 may be reduced. Thus, power may be saved during time intervals 220.

In FIG. 1, while at least a portion of controller core unit 102, such as PHY 110, is in power-down intervals 220, some internal circuitry or logic of controller core unit 102 or power control circuit 105 may need to connect to V1 at all times to maintain some functionality or communication between controller core unit 102 and power control circuit 105 or host system controller 104. For example, power control circuit 105 may need to be connected to V1 to recognize communication or signals such as the PPD signal to start each power-up and power-down sequence 230. Therefore, V1 in FIG. 1 remains unchanged and connected to some portion of controller core unit 102 or power control logic 106.

During power-down intervals 220, at least a portion of controller core unit 102, such as some circuitry of PHY 110, may not be needed. Therefore, power may be disconnected from at least a portion of controller core unit 102, such as from PHY 110, to reduce the leakage power. In some embodiments, at least a portion of controller core unit 102, such as PHY 110, use power provided by V2 at power terminal 122 (FIG. 1). Therefore, when power control circuit 105 of FIG. 1 disconnects V2 from VX, the affect to V2 at power terminal 122 of FIG. 1 is shown in FIG. 2 during time interval 220.

FIG. 2 also shows the presence and absence of network link 190 of FIG. 1 at PHY interface 112 of FIG. 1. Between times T0 and T5, network link 190 is absent. In some embodiments, the absence of network link 190 corresponds to PHY interface 112 being unconnected to network link 190. In other embodiments, the absence of network link 190 corresponds to PHY interface 112 being connected to network link 190 but no active communication is exchanged between network controller 100 and network 199. In FIG. 2, network link 190 is present at time T5. In some embodiments, the presence of network link 190 at time T5 corresponds to PHY interface 112 being re-connected to network link 190 at time T5 to establish an active communication between network controller 100 and network 199. In other embodiments, the presence of network link 190 at time T5 corresponds to an active communication being re-established on a connection that exists between PHY interface 112 and network 199 before time T5. As mentioned in FIG. 1, the presence and absence of network link 190 may be determined by energy detection, by impedance value detection, or by other methods.

In FIG. 2, the operation performed in each of the time intervals 230 is referred to as a power-up and power-down sequence. The operation performed between times T0 and T7 is referred to as a periodic power-down process.

At time T0, a periodic power-down (PPD) signal is asserted. The PPD signal may be asserted by controller core unit 102 or by power control circuit 105 of FIG. 1. In FIG. 2, after the PPD signal is asserted at time T0, power control switch 108 connects at least a portion of controller core unit 102, such as PHY 110, to V2 (FIG. 1).

At time T1, the voltage level of V2 reaches a stable level at voltage level 202. Between T1 and T2, PHY 110 detects a presence and an absence of network link at PHY interface 112. As shown in FIG. 2, between times T1 and T2, network link 190 is absent.

At time T2, controller core unit 102 concludes that network link 190 is absent. In this situation, power control switch 108 disconnects at least a portion of controller core unit 102, such as PHY 110, from V2 to save power. In FIG. 1, since at least a portion of controller core unit 102, such as PHY 110, is disconnected from V2, the voltage at power terminal 122 drops. As shown in FIG. 2, at time T2, the voltage level of V2 drops to voltage level 203 or ground. At least a portion of controller core unit 102, such as PHY 110, remains in power-down interval 220 between times T2 and T3.

The power-up and power-down sequence 230 is periodically repeated at times T3, T4, and T6. In the example of the timing diagram of FIG. 2, network link 190 may be unconnected to PHY interface 112 between times T0 and T5. Therefore, network link 190 is absent from PHY interface 112 between times T0 and T5. At time T5, network link 190 may be connected to PHY interface 112 or active communication is re-established between network controller 100 and network 199. Therefore, network link 190 is present at time T5.

In the operation between times T6 and T7, at least a portion of controller core unit 102, such as PHY 110, detects the presence of network link 190. Since network link 190 is present, power control switch 108 maintains the connection between at least a portion of controller core unit 102 and V2. As shown in FIG. 2, at time T7, V2 does not drop to voltage level 203. V2 remains at voltage level 202 from time T7 to time T8. Network controller 100 establishes a normal communication link with network 199 between times T7 and T8. Power control circuit 106 may terminate the periodic power-down process.

As shown in FIG. 2, at least a portion of controller core unit 102, such as PHY 110, may be configured to be periodically placed in the power-down intervals 220 in the absence of network link 190. In some embodiments, power-up interval 210 and power-down interval 220 may be set such that power-down interval 220 is greater than power-up interval 210. For example, power-down interval 220 may be set to 300 milliseconds and power-up interval 210 may be set to 100 milliseconds.

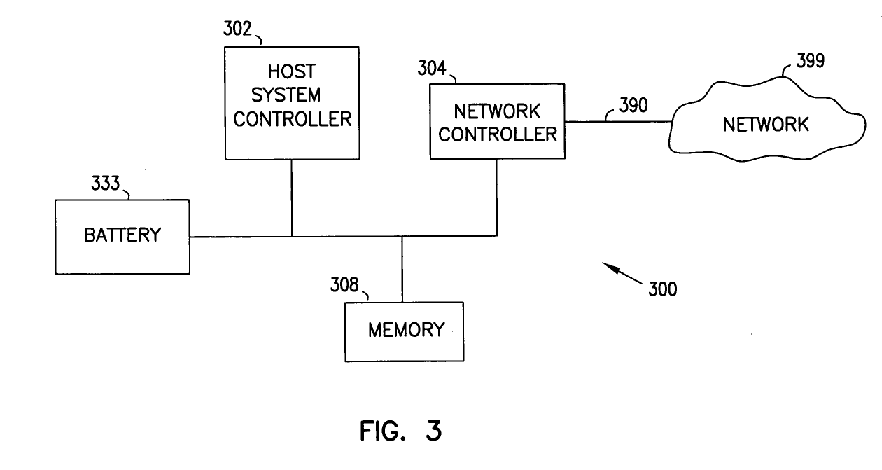

FIG. 3 shows a system according to an embodiment of the invention. System 300 includes a host system controller 302, a memory 308, and a network controller 304 to connect to a network 399.

System 300 further includes a battery 333 to supply power to system 300. For example, battery 333 may supply voltages such as V1 and VX. In some embodiments, instead of using power from a battery such as battery 333, system 300 may use power supplied from an electrical outlet such as a home or office electrical outlet.

Host system controller 302 may include a general purpose processor such as a microprocessor for a computer. Host system controller 302 may also include an application specific integrated circuit. In some embodiments, network controller 304 includes embodiments of network controller 100 of FIG. 1.

System 300 communicates with a network 399 via a network link 390. Network link 390 may include a network interface such as magnetic components. In some embodiments, network link 390 includes wired medium such as fiber optic cables and copper wires. In some other embodiments, network link 390 includes wireless media.

In system 300, to save power when network link 390 is absent, at least a portion of network controller 304 may be periodically placed into a power-down interval such as the periodic power-down intervals as described in FIG. 1 and FIG. 2. For example, when network link 390 is not connected to network controller 304, at least a portion of network controller 304, such as a PHY in FIG. 1, may be periodically placed into a power-down interval to save power.

The illustration of system 300 in FIG. 3 is intended to provide a general understanding of the structure of various embodiments described herein. System 300 is not intended to serve as a complete description of all the elements and features of systems that might make use of the structures described herein.

Using the periodic power-down technique described herein may improve power management in system 300 such as reducing or eliminating a leakage power. Thus, the life of battery 333 may be extended.

System 300 of FIG. 3 includes computers (e.g., desktops, laptops, hand-helds, servers, Web appliances, routers, etc.), communication devices (e.g., wireless LAN, wired LAN, cellular phones, cordless phones, pagers, personal digital assistants, etc.), computer-related peripherals (e.g., printers, scanners, monitors, etc.), entertainment devices (e.g., televisions, radios, stereos, tape and compact disc players, video cassette recorders, camcorders, digital cameras, MP3 (Motion Picture Experts Group, Audio Layer 4) players, video games, watches, etc.), and the like.

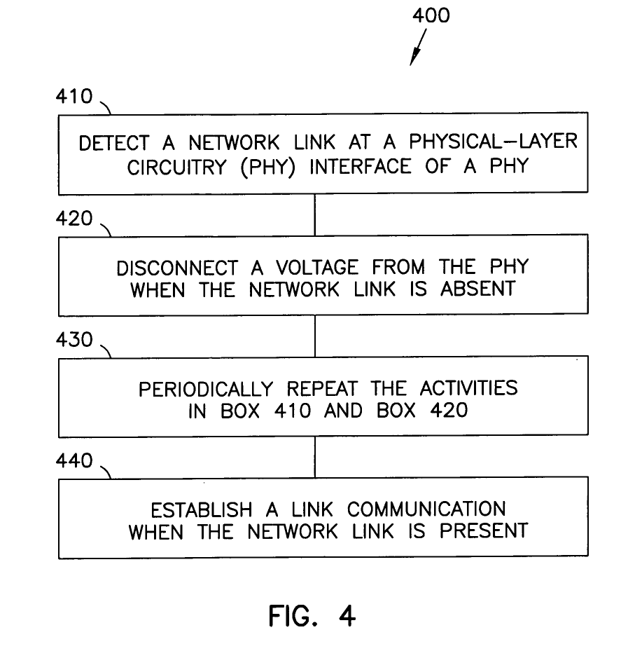

FIG. 4 is a flowchart showing a method according to an embodiment of the invention. In some embodiments, method 400 may be used in network controller 100 of FIG. 1 and system 300 of FIG. 3. Method 400 reduces power consumption in a network controller while maintaining network link detection capability.

In FIG. 4, box 410 detects a network link at a PHY interface of a PHY of a network controller. In some embodiments, a presence and absence of the network link at PHY interface is identified by energy detection, impedance values detection (described in FIG. 1 through FIG. 3), or other methods. In some embodiments the PHY may transmit NPL or FPL to establish a communication between the network controller and a network via the network link. In some embodiments, box 410 detects the presence of the network link by sensing a link signal or pulses at PHY interface. The presence or absence of the link signal indicates a connection or disconnection of the network link at the PHY interface.

Box 420 disconnects a voltage, such as V2 in FIG. 1, from the PHY or from a power terminal of at least a portion of a controller core unit of the network controller when the network link is absent. Since at least a portion of the controller core unit (for example, the PHY) is disconnected from V2, any leakage powder from the portion of the controller core unit at the power terminal is reduced. Thus, power is saved during the activity in box 420.

In box 430, method 400 periodically repeats the activities in box 410 and box 420. In some embodiments, method 400 periodically repeats the activities in box 410 and box 420 until the network link is detected or present. In some embodiments, the presence of the network link indicates that the network link is connected to the PHY. When method 400 detects the presence of the network link, method 400 stops disconnecting the controller core unit from the voltage V2 after the detection process in box 410 is performed.

Box 440 establishes link communication when the network link is present. In box 440 the network controller may exit the periodic power-down process when the network link is present. The PHY establishes link communication to communicate with the network through the network link.

The individual activities shown in FIG. 4 do not have to be performed in the order illustrated or in any particular order. Moreover, various activities described with respect to the methods identified herein can be executed in serial or parallel fashion. Some activities may be repeated indefinitely, and others may occur only once. Various embodiments may have more or fewer activities than those illustrated.

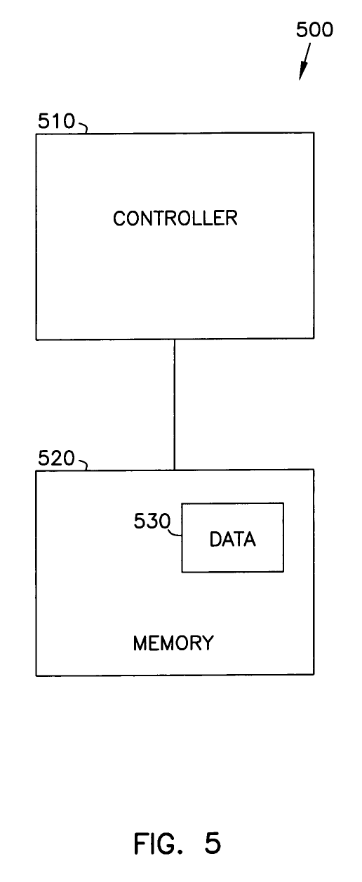

FIG. 5 is a block diagram of an article 500 according to an embodiment of the invention. Article 500 may include a computer, a memory system, a magnetic or optical disk, other type of storage devices, a hand-held system such as a cellular phone, or other electronic systems. Article 500 includes a controller 510 coupled to a machine-accessible medium such as a memory 520.

Controller 510 may include any combination of a general-purpose processor, an application specific integrated circuit, a chipset including an input/output control unit. The input/output control unit may include a MAC circuit, a PHY, and other component of an apparatus or system such as network controller 100 of FIG. 1 or system 300 of FIG. 3.

Memory 520 may be removable storage media. Memory 520 may include any type of memory such as electrical, optical, or electromagnetic. Memory 520 has associated information or data 530. Examples of associated information 530 are computer program instructions.

Associated information 530, when accessed, results in a machine (for example, controller 510) performing activities such as detecting a network link at a PHY interface of a PHY, and disconnecting the PHY from a voltage when the network link is absent. The detecting and disconnecting activities may be periodically performed. Other activities may include establishing a link communication with a network when the network link is present. The activities performed when associated information 530 is accessed may include activities described in FIG. 1 through FIG. 4.

Improved power management may result from implementing the apparatus, systems, and methods described in FIG. 1 through FIG. 5.

The above description and the drawings illustrate some specific embodiments of the invention sufficiently to enable those skilled in the art to practice the embodiments of the invention. Other embodiments may incorporate structural, logical, electrical, process, and other changes. In the drawings, like features or like numerals describe substantially similar devices throughout the several views. Examples merely typify possible variations. Portions and features of some embodiments may be included in or substituted for those of others. Many other embodiments will be apparent to those of skill in the art upon reading and understanding the above description. Therefore, the scope of various embodiments is determined by the appended claims, along with the full range of equivalents to which such claims are entitled.

What is claimed is:

1. An apparatus comprising:
a controller core unit including a physical-layer circuitry (PHY), the PHY including a PHY interface to connect to a network link to communicate with a network, and a power terminal to receive a first voltage, the PHY being configured to detect the presence and absence of the network link at the PHY interface; and
a power control circuit to disconnect at least a portion of the controller core unit from the first voltage when the network link is absent.

2. The apparatus of claim 1, wherein the power control circuit is configured to periodically enable the PHY to periodically detect the network link at the PHY interface.

3. The apparatus of claim 2, wherein the power control circuit is configured to periodically disconnect the portion of the controller core unit from the first voltage when the network link is absent.

4. The apparatus of claim 3, wherein the PHY interface is configured to receive a link signal, wherein the network link is absent when the link signal is not received, and wherein the network link is present when the link signal is received.

5. The apparatus of claim 4, wherein the power control circuit is configured to stop disconnecting the portion of the controller core unit from the first voltage when the network link is present.

6. The apparatus of claim 3, wherein the PHY interface is configured to determine an impedance at the PHY interface, wherein the network link is absent when the impedance has a first value, and wherein the network link is present when the impedance has a second value.

7. The apparatus of claim 3, wherein the controller core unit further includes a second power terminal to receive a second voltage, and wherein the controller core unit is configured to maintain a connection with the second voltage when the portion of the controller core unit is periodically disconnected from the first voltage.

8. The apparatus of claim 3, wherein the PHY includes a transmitter and a receiver to transfer data with the network link.

9. The apparatus of claim 8, wherein the controller core unit further includes a media access control (MAC) circuit to control the PHY.

10. A method comprising:
detecting a network link at a physical-layer circuitry (PHY),interface of a PHY of a network controller, the network controller including a first power terminal connected to first voltage, and a second power terminal connected to a second voltage; and
disconnecting at least a portion of the network controller from the second voltage when the network link is absent.

11. The method of claim 10, wherein detecting the network link is periodically repeated until the network link is present.

12. The method of claim 1 1, wherein disconnecting at least the portion of the network controller is periodically repeated until the network link is present.

13. The method of claim 12, wherein the network controller is connected to both the first and second voltages during the detecting of the network link.

14. The method of claim 13 further comprising:
keeping the network controller connected to the first voltage when the network controller is disconnected from the second voltage.

15. The method of claim 14, wherein detecting the network link from the PHY interface includes detecting a link energy at the PHY interface, wherein the network link is absent when the link energy is absent, and wherein the network link is present when the link energy is present.

16. The method of claim 15, wherein detecting the link energy includes detecting a link signal at the PHY interface, wherein the link energy is absent when the link signal is not received, and wherein the link energy is present when the link signal is received.

17. The method of claim 16, wherein detecting the network link from the PHY interface includes determining an impedance at the PHY interface, wherein the network link is absent when the impedance has a first value, and wherein the network link is present when the impedance has a second value.

18. The method of claim 17, wherein the first voltage and the second voltage have different values.

19. The method of claim 18, wherein detecting the network link is performed during a first time interval, and wherein disconnecting at least the portion of the network controller from the second voltage includes disconnecting the portion of the network controller from the second voltage for a second time interval.

20. A system comprising:
a network controller including a physical-layer circuitry (PHY), the PHY including a PHY interface to connect to a network link to communicate with a network, a first power terminal to receive a first voltage, a second power terminal to receive a second voltage, the PHY being configured to detect the presence and absence of the network link at the PHY interface, a power control circuit to disconnect at least a portion of the controller core unit from the first voltage when the network link is absent; and
a battery to provide at least one of the first and second voltages.

21. The system of claim 20, wherein the power control circuit is configured to periodically enable the PHY to periodically detect the network link at the PHY interface.

22. The system of claim 21, wherein the power control circuit is configured to periodically disconnect the portion of the controller core unit from the first voltage when the network link is absent.

23. The system of claim 22, wherein the PHY interface is configured to receive a link signal, wherein the network link is absent when the link signal is not received, and wherein the network link is present when the link signal is received.

24. The system of claim 23, wherein the power control circuit is configured to stop disconnecting the portion of the controller core unit from the first voltage when the network link is present.

25. The system of claim 24, wherein the PHY interface is configured to determine an impedance at the PHY interface, wherein the network link is absent when the impedance has a first value, and wherein the network link is present when the impedance has a second value.

26. An article including a machine-accessible medium having associated information, wherein the information, when accessed, results in a machine performing:
detecting a network link at a physical-layer circuitry (PHY) interface of a PHY of a network controller, the network controller including a first power terminal connected to first voltage, and a second power terminal connected to a second voltage; and
disconnecting at least a portion of the network controller from the second voltage when the network link is absent.

27. The article of claim 26, wherein detecting the network link is periodically repeated until the network link is present.

28. The article of claim 27, wherein the disconnecting the network controller is periodically repeated until the network link is present.

29. The article of claim 28, wherein the network controller is connected to both the first and second voltages during detecting the network link.

30. The article of claim 29, wherein detecting the network link is performed during a first time interval, and wherein disconnecting the portion of the network controller from the second voltage includes disconnecting the portion of the network controller from the second voltage for a second time interval.
